(19) United States
(12) Patent Application Publication
(10) Pub. No.: US 2025/0030973 A1
(43) Pub. Date: Jan. 23, 2025

(54) ROTATING HEADPHONE STAND

(71) Applicant: Raptorex LLC, Wixom, MI (US)

(72) Inventor: Jay LANGE, Wixom, MI (US)

(73) Assignee: Raptorex LLC, Wixom, MI (US)

(21) Appl. No.: 18/353,230

(22) Filed: Jul. 17, 2023

(51) Int. Cl. H04R 1/10; F03G 7/00; F21K 9/20; H01H 13/81

(52) U.S. Cl. CPC H04R 1/1091; F03G 7/025; F21K 9/20; H01H 13/81; F21W 2131/301; F21Y 2115/10; H04R 2201/02; H04R 2460/17

(57) ABSTRACT

A headphone stand may be provided. The headphone stand may include a headphone base, and an upper portion attached to the headphone base. The headphone base may have a stem, a first end of the stem may be attached to the headphone base while a second end of the stem may be attached to a headphone holder. The headphone stand may further include a rotation means, which may allow for the upper base portion to automatically rotate independent of the headphone base.

### BACKGROUND

Headphones are often stored on shelves or desks, on stationary stands. However these options are lackluster, for example some people may find them visually unappealing, especially in scenarios where, for example, headphones are being displayed for sale or to otherwise attract customers. Additionally, headphones left lying on shelves or the like may be more prone to being damaged, destroyed, or lost.

### SUMMARY

In one or more embodiments a headphone stand may be provided. The headphone stand may include a headphone base, and an upper portion attached to the headphone base. The headphone base may have a stem, a first end of the stem may be attached to the headphone base while a second end of the stem may be attached to a headphone holder. The headphone stand may further include a rotation means, which may allow for the upper base portion to automatically rotate independent of the headphone base.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 shows a front view of an exemplary rotating headphone stand.

FIG. 2 shows a top view of the exemplary rotating headphone stand.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

In one or more exemplary embodiment a rotating headphone stand may be provided.

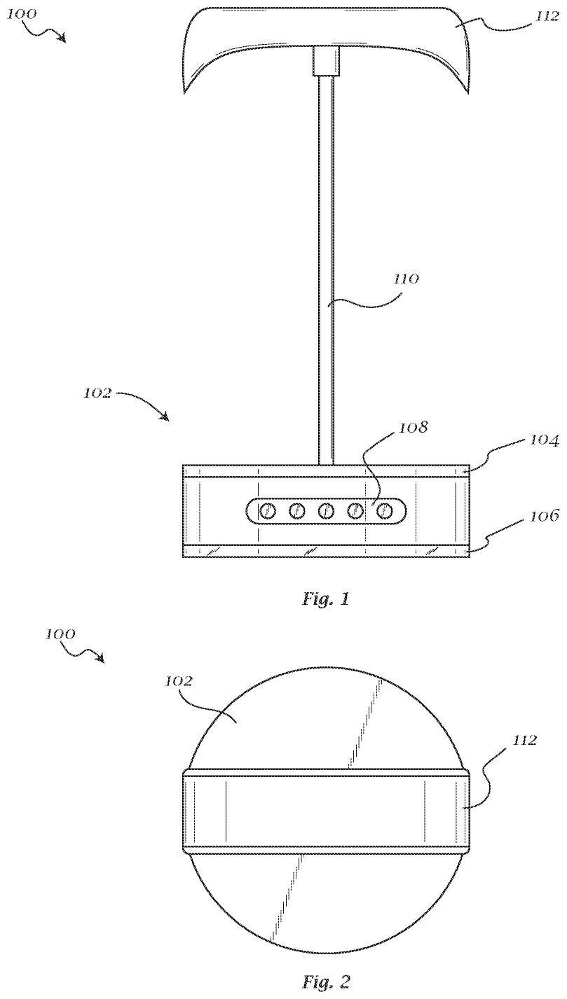

Referring to FIGS. 1-2 an exemplary rotating headphone stand 100 may be shown and described, where FIG. 1 is a front view of the exemplary headphone stand 100 and FIG. 2 is a top view of the exemplary headphone stand 100. The rotating headphone stand 100 may have a base 102. The base 102 may be made of, for example, plastic, metal, wood, etc. The base may have an upper base portion 104. The upper base portion 104 may be connected to the base 102 in a way that allows the upper base portion 104 to rotate independent of the base 102, that is to say the upper base portion 104 rotates while the base 102 stays still. The connection may be, for example, being formed as a single piece, being glued or otherwise adhered, being screwed or bolted, etc. The upper base portion 104 may further be connected to a rotation means, for example a motor, actuator, magnetic rotation, etc. For example, in an embodiment the motor may turn a small gear, which may be connected to a large gear that turns the upper base portion 104. In some embodiments the turning mechanism may be contained within the base 102. When powered the turning mechanism may cause the upper base portion 104 to automatically rotate.

In some embodiments the base 102 may further include lights 106, which may be, for example, an LED strip. The lights 106 may further have a clear plastic strip, glass panel, or other protective barrier embedded in the base 102. The base 102 may further include a plurality of buttons 108, which may control, for example, whether the upper base 104 is rotating, the speed of rotation, turning the lights 106 on or off, brightness of the lights, etc. In some embodiments the lights 106 may pulsate, and the speed, color, and color pattern may be adjusted using the buttons 108. The headphone stand 100 may further include a stem 110 with a first end connected to the upper base 104. The stem 110 may be made of, for example, plastic, metal, wood, etc. when the upper base 104 rotates, the stem 110 may also rotate with the upper base 104. The stem 110 may be cylindrical in shape, or in other embodiments may be various other shapes, for example rectangular, square, star shaped, etc. In an exemplary embodiment the stem 110 may be two or more threaded shafts connected to each other, and may thread into the base 102.

The headphone stand 100 may further a headphone holder 112 attached to a second end of the stem 110. The headphone holder 112 may be made of, for example, plastic, metal, wood, etc. The headphone holder 112 may have a flat section and one or more ridges or walls, which may help stabilize headphones placed in the headphone holder. For example, in an embodiment there may be a wall lengthwise along each edge of the headphone holder. In some embodiments the headphone holder 112 may also have a curve that fits the curve of a headphone, for example the ends of the headphone holder 112 may have a downward slope. In some embodiments the slope may be fit to a specific kind or brand of headphone. It may be understood that the slope and walls of the headphone holder 112 may hold a headphone placed in the holder in place, even during rotation of the headphone stand 100.

In other embodiments the headphone stand 100 may hold other devices, for example a VR or AR headset. The headphone stand 100 may further contain a wireless charging port and/or a wired charging port, which may be contained on the upper base portion 104. The headphone stand 100 may further contain additional control features, for example switches, which may be used to power the headphone stand 100 on or off.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A headphone stand, comprising:
a headphone base,
an upper base portion attached to the base;
a headphone stand stem attached to the upper base portion from a first end of the headphone stand stem;
a headphone holder attached to a second end of the headphone stand stem; and
a rotation means, wherein the rotation means is configured to automatically rotate the upper base portion independent of the headphone base.

2. The headphone stand of claim 1, wherein the rotation means is contained within the headphone base.

3. The headphone stand of claim 2, wherein the rotation means is a motor or actuator.

4. The headphone stand of claim 1, further comprising one or more lights attached to the base portion.

5. The headphone stand of claim 4, wherein the one or more lights are one or more LED strips.

6. The headphone stand of claim 5, further comprising one or more buttons attached to the headphone base.

7. The headphone stand of claim 6, wherein the one or more buttons control at least the brightness of the one or more LED strips and the speed of rotation of the upper base portion.

8. The headphone stand of claim 1, wherein the headphone holder further comprises a first ridge on a first edge of the headphone holder and a second ridge on a second edge of the headphone holder, configured such that when a headphone is placed on the headphone holder the headphone will not fall off the headphone holder.

9. The headphone stand of claim 8, wherein the headphone stand stem is further comprised of at least two threaded shafts configured to connect together, and further configured to thread into the upper base portion.

10. The headphone stand of claim 1, wherein the headphone holder further comprises a first ridge on a first edge of the headphone holder and a second ridge on a second edge of the headphone holder, configured such that when a VR or AR headset is placed on the headphone holder the VR or AR headset will not fall off the headphone holder.
